(19) United States
(12) Patent Application Publication
(10) Pub. No.: US 2013/0053812 A1
(43) Pub. Date: Feb. 28, 2013

(54) CLAMP AND CLAMPING SYSTEM AND USE THEREOF

(71) Applicants: Björn Lehmann, Bad Hersfeld (DE); Steffen Roser, Bad Vilbel (DE); Harry Pütter, Bad Salzschlirf (DE)

(72) Inventors: Björn Lehmann, Bad Hersfeld (DE); Steffen Roser, Bad Vilbel (DE); Harry Pütter, Bad Salzschlirf (DE)

(73) Assignee: Fresenius Kabi Deutschland GmbH, Bad Homburg (DE)

(21) Appl. No.: 13/634,304

(22) PCT Filed: Mar. 15, 2011
(86) PCT No.: PCT/EP2011/053828

§ 371 Date: Nov. 6, 2012

Related U.S. Application Data
(60) Provisional application No. 61/313,821, filed on Mar. 15, 2010.

(30) Foreign Application Priority Data
Mar. 15, 2010 (EP) 10156519.0

(51) Int. Cl. F16M 13/02; F16K 43/00

(52) U.S. Cl. 604/403; 248/316.7; 137/315.01

(57) ABSTRACT

A clamp for receiving cylindrical objects, comprising a main body, which on two opposite sides has connecting elements that are matched to one another for detachably connecting similar clamps, and a receiving region, which is designed in a substantially ring segment shape and has a receiving opening for connecting a cylindrical object to the main body in a detachable locking manner, said opening extending over less than 180° of the receiving region, and the inside diameter (D) of the receiving region being 32 mm, 17 mm to 24 mm, or 10 mm.

The invention relates to a clamp for receiving cylindrical objects, with a main body which has connecting elements for releasable connection to similar clamps, and with a receiving area for releasably connecting a cylindrical object to the main body. The invention further relates to a system composed of at least two clamps, to the combination of such a system and a stopcock manifold, and to the use of a clamp and/or of a system composed of several clamps for receiving syringes.

Clamps of the abovementioned kind are known, for example from DE 295 03 957 U1. These clamps known from the prior art are used for securing pipes or cables, particularly in buildings. In general, clamps of this kind are at any rate suitable for connection to identical clamps, sometimes using additional connecting means. It is therefore not possible for pipes with different cross sections to be secured by inter-connected clamps of a single system.

In medicine, it is known that, for some purposes, medicaments have to be administered one after another, or components of a medicinal mixture that is unstable during storage have to be mixed together just shortly before use. Normally, the different medicaments are each dosed into the infusion bag through an access port using a syringe. Since the medicaments are generally supplied in pharmacies, there is the danger of the individual components of a mixture getting mixed up during transport or storage, making safe allocation difficult. Moreover, the sometimes relevant sequence of dosing of the medicaments has hitherto been ensured only with difficulty. The same problems arise when the medicaments are administered by patients themselves, e.g. when used at home.

The object of the present invention is therefore to make available a clamp and a system of clamps that permit safe storage and allocation, in particular of filled syringes of different sizes.

According to the invention, this object is achieved by a clamp having the features of claim 1. Such a clamp preferably has a main body which, on two opposite sides, has connecting elements that are matched to each other and that serve in particular for the releasable connection of similar clamps, and a receiving area which, in order to permit a releasable latch connection of a cylindrical object, for example a syringe, on the main body, is designed with substantially the shape of a ring segment and with a receiving opening that extends preferably over less than 180° of the receiving area. This dimensioning of the receiving opening of the jaw-like receiving area permits rapid and easy securing of a syringe or the like in the clamp, preferably by a latch connection or snap connection. According to the invention, the internal diameter of the receiving area is adapted to the external diameter of a syringe. The internal diameters of the receiving area can, for example, measure from 10 mm for small-volume syringes up to 32 mm for large-volume syringes. It is also preferable if the individual clamps can be inter-connected directly via their connecting elements.

In principle, in a clamp according to the invention, the receiving opening of the receiving area can be kept very small or can even be dispensed with altogether, with the result that the receiving area is designed as a substantially or completely closed ring. A syringe then has to be plugged into this ring-shaped receiving area in the direction of the longitudinal axis.

The clamp according to the invention and the system described in more detail below represent a simple and reliable aid for preparation of several medicaments and permit an easily manageable presentation form. In particular, preparation, for example in a pharmacy or in a hospital, is made considerably easier since a rapid and simple connection of syringes to a stopcock manifold (obtainable for example from Fresenius Kabi as a “5-way stopcock” under order number 8501342) is possible. Thus, the sequence of dosing of medicaments in cases of use by the patient can be made easier, for example by corresponding color coding of the cocks of the stopcock manifold.

The clamp according to the invention is preferably used as a disposable part that is discarded after use. For this reason, inexpensive production, for example as a one-piece plastic injection molded component, is preferred. In principle, a clamp according to the invention can also be made of other suitable materials, for example of metal. In order to ensure, when using several clamps in combination with a stopcock manifold, that the outlet nozzles of the syringes are arranged, regardless of their diameter, in a common plane and at a uniform spacing predefined by the inlet nozzles of the stopcock manifold, the receiving area can be integrated directly into the main body, can be arranged on the latter, or can be connected thereto by way of an interposed spacer.

The object of the invention is further achieved by a system as claimed in claim 3. In a system according to the invention composed of several clamps, for example of the abovementioned type, of which at least two clamps are different from each other, all of the clamps have a main body which is identical, at least in respect of its dimensions in the direction of width, and which, on two opposite sides, has connecting elements that are matched to each other and that serve for connection to further clamps of the system. In other words, not only can clamps for receiving syringes of different sizes be connected to one another, the width of the interconnected clamps of the system is the same and preferably adapted to the distances between inlet nozzles of a stopcock manifold, independently of the size of the syringes received therein. Moreover, the clamps of the system have if appropriate a spacer and a receiving area which, in order to permit connection to a syringe or similar cylindrical object, is designed for example with the shape of a ring segment and defines a longitudinal axis. In the case of syringes that have a central outlet nozzle, this longitudinal axis of the receiving area coincides with the longitudinal axis of this outlet nozzle. According to the invention, the main bodies and receiving areas of the clamps are configured in such a way that, when three clamps differing from one another in terms of different internal diameters of their receiving areas are connected to one another, their longitudinal axes lie in a common plane and/or at an identical distance from one another. It is thus possible for syringes of any size to be secured in a defined sequence in clamps of the system according to the invention for storage and transport, such that the syringes, in the state in which they are received in the clamps, can be attached directly to a stopcock manifold.

In a system according to the invention composed of at least two different clamps, the receiving area of at least one of these clamps is designed with an internal diameter of approximately 10 mm, ca. 17 mm, ca. 24 mm and/or approximately 32 mm. This permits rapid and easy securing of conventional disposable syringes in clamps of the system.

For attachment to a stopcock manifold, it is preferable if the main bodies and receiving areas of the clamps are configured in such a way that, when two different clamps are connected to each other, their longitudinal axes lie at a distance of approximately 36 mm from each other.

The receiving areas of the clamps serve, for example, as latch connection elements and preferably have the same extent in the direction of their longitudinal axes.

The invention further relates to a combination of at least one clamp and a system of the abovementioned type and a stopcock manifold having at least three attachment nozzles that can each be closed by a respective stopcock and that serve for coupling to a syringe, all of the attachment nozzles opening into a common collecting channel with an outlet attachment. It is preferable, according to the invention, if the distances between the attachment nozzles of the stopcock manifold and the clamps of the system are adapted to each other in such a way that syringes of different sizes, received in interconnected clamps of the system, can be attached directly to the stopcock manifold. Preferably, at least one clamp is connected to the stopcock manifold directly or indirectly, for example by means of a syringe.

The invention further relates to the use of a clamp or of a system of the aforementioned type for transporting and/or storing medicaments contained in syringes, in particular components of a medicament mixture that is unstable during storage, for example a chemotherapeutic or an analgesic. Particularly preferable is the use for home administration of several medicaments that have to be administered and/or prepared in a defined sequence and/or in a defined mixing ratio.

According to a further embodiment of the invention, a non-return valve is additionally integrated or provided between the syringe and the 3-way component, in order to avoid liquids being accidentally forced back into one of the syringes.

The invention is explained in more detail below on the basis of an illustrative embodiment and with reference to the schematic drawing, in which:

FIG. 1 shows a perspective plan view of two clamps according to the invention,

FIG. 2 shows the clamps according to FIG. 1 in a perspective view from underneath,

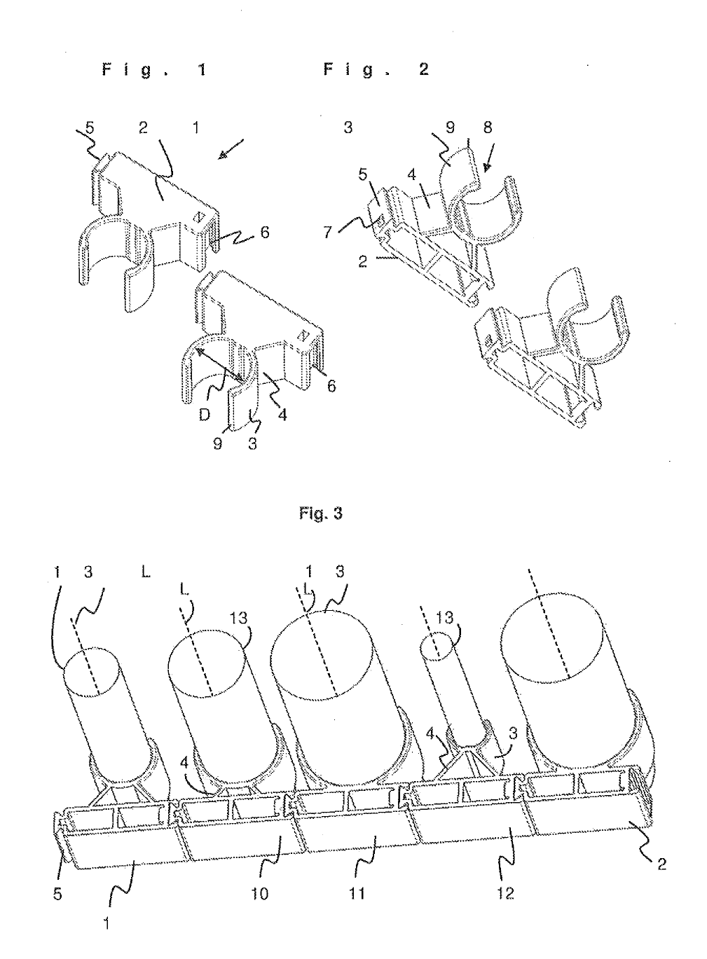

FIG. 3 shows a system according to the invention composed of several clamps, and

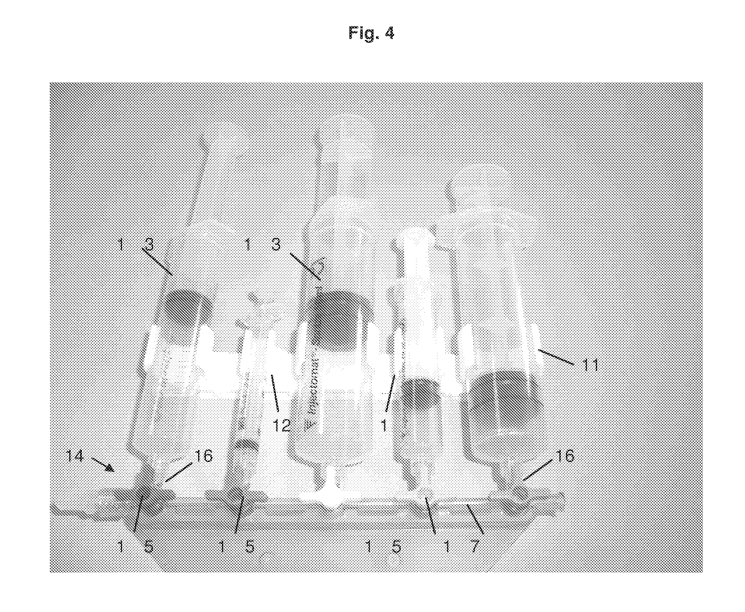

FIG. 4 shows a system according to the invention composed of several clamps connected to a stopcock manifold.

The clamps 1 shown in FIGS. 1 and 2 are basically composed of a main body 2 and of a jaw-like receiving area 3 which, in the embodiment shown, is connected in one piece to the main body 2 via a spacer. The whole clamp 1 is produced as an injection-molded plastic part.

The main body 2 is provided, on its right-hand side in FIG. 1, with a dovetail-shaped projection 5 and, on its opposite side, with a correspondingly contoured groove 6, and these together form connecting elements that are matched to each other and that serve for the connection of two clamps 1. In an alternative to the projection 5 and to the corresponding groove 6 shown in the illustrative embodiment in FIGS. 1 and 2, it is also possible to provide other cross sections, for example an approximately mushroom-shaped projection or a T-shaped projection and a correspondingly configured groove, which permit permanent or releasable connection of two clamps.

In order to ensure that unwanted release of the connection of two clamps 1 during transport is prevented or made difficult, the projection 5 in the embodiment shown is provided with a latching nose 7 which, when two clamps 1 are connected, can latch into a corresponding recess (not shown) in the groove 6.

The receiving area 3 of the clamp 1 is designed substantially in the shape of a ring segment, with a receiving opening 8 remaining between the two curved branches of the receiving area and extending over less than 180° of the receiving area 3. In other words, the receiving area 3 can, with its two branches, engage around a cylindrical object, for example a syringe, by more than 180° in the manner of a latch connection or snap connection. For this purpose, the two branches of the receiving area 3 can be made resilient by suitable choice of material and/or design means. Moreover, in the embodiment shown, the ends of the two branches of the receiving area 3 that are directed away from the main body 2 are provided with a bead-like thickening 9, which facilitates the engagement of a syringe or the like and makes it difficult for a syringe to accidentally fall out of the clamp 1.

The receiving area 3 partially encloses an at least substantially cylindrical space, of which the internal diameter D, delimited by the branches of the receiving area 3, is adapted to the external dimensions of a syringe. Thus, for example, the internal diameter D can be approximately 10 mm to 32 mm.

FIG. 3 shows a system according to the invention composed of several clamps 1, 10, 11 and 12. All of the clamps of this system have substantially the same configuration, and in particular the main body 2 is in each case substantially identical. However, the clamps 1, 10, 11 and 12 differ from one another in particular in terms of the internal diameter D defined by the branches of the respective receiving areas 3. Thus, the clamps 1, 10, 11 and 12 are suitable for receiving and securing syringes 13 of different sizes, which are indicated schematically by cylinders in FIG. 3.

The clamps 1, 10, 11 and 12 also differ from one another in terms of the size of the spacer 4. Thus, in the clamp 11 for receiving a large syringe, the spacer is completely omitted, whereas the spacer 4 in the clamp 12 for receiving a syringe of small diameter is particularly large. In principle, it would also be possible, in a departure from the embodiments shown, for the receiving area 3 for particularly large syringes to be integrated at least partially in the main body 2.

The clamps 1, 10, 11 and 12, as component parts of a system, are adapted to one another in such a way that they can be secured to one another in any desired sequence via structurally identical connecting elements, i.e. projections 5 and grooves 6. The main bodies 2, the receiving areas 3 and, if appropriate, the spacers 4 are designed such that the longitudinal axes L, defined by the respective branches of the receiving areas 3, coincide with the longitudinal axes of the syringes 13 received in the clamps, lie in a common plane, regardless of the size of the syringe 13, and are at the same distance from one another. In other words, the free space between two large syringes each received in a clamp 11 is smaller than the free space between two small syringes each received in a clamp 12. By virtue of the arrangement of the longitudinal axes L in a common plane and at the same distance from one another, regardless of the syringe size, it is also possible for syringes of different sizes, latched in several interconnected clamps 1, 10, 11 and/or 12, to be attached to a stopcock manifold (not shown), of which the attachment nozzles lie at a defined distance from one another and in a common plane.

FIG. 4 shows a stopcock manifold 14 with several stopcocks which, in the embodiment shown, are designed as 3-way stopcocks 15. The stopcocks 15 are each assigned to respective attachment nozzles 16, which in turn open into a common collecting channel 17 with an outlet attachment. Syringes 13 are received in the interconnected clamps 1, 10, 11, 12 and are each connected to an attachment nozzle 16. In this way, the clamps are connected to the stopcock manifold 14 via the syringes 13. In a departure from the embodiment shown, a direct connection can also be provided between the stopcock manifold and the clamps.

It is also possible in principle, in a departure from the view shown in the figures, to dispense completely with a receiving opening 8 of the receiving area 3, such that the receiving areas are designed as a closed ring. A syringe then has to be plugged into the ring-shaped receiving area in the direction of the longitudinal axis L. However, preference is given to the embodiment shown in the figures, which permits a latch connection or snap connection to syringes or the like.

### LIST OF REFERENCE SIGNS

1 clamp

2 main body

3 receiving area

4 spacer

5 projection

6 groove

7 latching nose

8 receiving opening

9 thickening

10 clamp

11 clamp

12 clamp

13 syringe

14 stopcock manifold

15 stopcock

16 attachment nozzle

17 collecting channel

D internal diameter

L longitudinal axis

1. A clamp for receiving cylindrical objects, with a main body which, on two opposite sides, has connecting elements that are matched to each other and that serve for the releasable connection of similar clamps, and with a receiving area which, in order to permit releasable latch connection of a cylindrical object on the main body, is designed with substantially the shape of a ring segment and with a receiving opening that extends over less than 180° of the receiving area, the internal diameter (D) of the receiving area measuring 32 mm, 17 mm to 24 mm, or 10 mm.

2. The clamp as claimed in claim 1, wherein the receiving area is connected in one piece to the main body, if appropriate with a spacer between them.

3. A system composed of at least three clamps, in particular as claimed in claim 1, in which all of the clamps have an at least substantially identical main body which, on two opposite sides, has connecting elements that are matched to each other and that serve for connection to further clamps of the system, if appropriate a spacer, and a receiving area which, for connection to a cylindrical object, is designed with substantially the shape of a ring or a ring segment and defines a longitudinal axis (L), characterized in that the main bodies and receiving areas of the clamps are configured in such a way that, when three clamps differing from one another in terms of different internal diameters (D) of their receiving areas are connected to one another, their longitudinal axes (L) lie in a common plane and/or at an identical distance from one another.

4. The system as claimed in claim 3, composed of at least two different clamps whose receiving areas have an internal diameter (D) of approximately 32 mm, approximately 17 mm to approximately 24 mm, or approximately 10 mm.

5. The system as claimed in claim 3, wherein the main bodies and receiving areas of the clamps are configured in such a way that, when two different clamps are connected to each other, their longitudinal axes (L) lie at a distance of approximately 36 mm from each other.

6. The system as claimed in claim 3, wherein the receiving area of at least one of the clamps is designed as a closed ring, into which a cylindrical object can be plugged.

7. The system as claimed in claim 3, wherein the receiving areas have the same extent in the direction of their longitudinal axes (L).

8. A combination of at least one clamp as claimed in claim 1 and a stopcock manifold having at least three attachment nozzles that can each be closed by a respective stopcock and that serve for coupling to a syringe, all of the attachment nozzles opening into a common collecting channel with an outlet attachment.

9. The combination as claimed in claim 8, c wherein at least one clamp is connected to the stopcock manifold.

10. A method of using the clamp as claimed in claim 1 comprising transporting and/or storing medicaments contained in syringes.

11. The method of claim 10 wherein transporting and/or storing components wherein each component is contained in a respective syringe and form part of a medicament mixture that is unstable during storage.

12. The method of claim 10 wherein transporting and/or storing medicaments includes transporting and/or storing chemotherapeutics or analgesics contained in syringes.
